(19) United States
(12) Patent Application Publication
(10) Pub. No.: US 2003/0178906 A1
(43) Pub. Date: Sep. 25, 2003

(54) Method for starting an eletric motor and electric motor with a device for starting the motor

(76) Inventor: Niels Christian Weihrauch, Nordhackstedt (DE)

Correspondence Address: ALTERA LAW GROUP, LLC, 6500 CITY WEST PARKWAY, SUITE 100, MINNEAPOLIS, MN, 55344-7704, US

(21) Appl. No.: 10/311,049

(22) PCT Filed: Jun. 14, 2001
(86) PCT No.: PCT/DK01/00401

(51) Int. Cl. H02K 47/18

(52) U.S. Cl. 310/161

(57) ABSTRACT

In a method for starting an electric motor, which is operated by alternating current and which has a stator (1) with a main winding (H) and a first auxiliary winding (AUX1) and a rotor with permanent magnets and at least one short-circuit winding, it is ensured that, in order to avoid a pole changing when starting against a high load torque until the rotor has reached synchronism with the rotating field generated by the stator windings, that first auxiliary winding (AUX1) and a second auxiliary winding (AUX2) of the stator (1) are alternatingly supplied with the alternating current in dependence of the alternating current polarity, until the rotor has reached an oversynchronous speed, after which the alternating current supply to the auxiliary windings (AUX1, AUX2) is interrupted or reduced, the current of the auxiliary windings (AUX1, AUX2) being supplied phase-shifted in relation the alternating current (i_{H}) being supplied to the main winding (H). For the same purpose, the motor is designed in such a way that the stator (1) has a second auxiliary winding (AUX2) and the magnetic axes (A_{AUX1}, A_{AUX2}) of the auxiliary windings (AUX1,AUX2) define an angle (α).

The invention concerns a method for starting an electric motor, which comprises a stator with a main winding and a first auxiliary winding, as well as a rotor with permanent magnets and at least one short-circuit winding, the motor being supplied with alternating current. Further, the invention concerns an electric motor having a device for starting the motor, the motor and the device to be connected to an alternating voltage source, a stator having a main winding and a first auxiliary winding, a rotor having permanent magnets and at least one short-circuit winding, and a phase shifting device which causes a phase shift between the current flowing through the main winding and the current flowing through the auxiliary winding.

A motor of this kind, also called “Line Start Motor”, has the ability of an asynchronous motor to generate a high starting torque as well as the ability of a synchronous motor to operate with a speed, which is synchronous with the rotating field, independently of the load.

The problem is to synchronise the rotor with the rotating field. This particularly applies when starting against a load torque. A possible solution is described in the U.S. Pat. No. 5,952,752, in which the rotor of a “Line Start Motor” is brought to the synchronous speed by means of pole changing from a low pole numbered winding to a high pole numbered winding. The method involves switching the first low pole numbered winding on and ramping the rotor up to a higher speed. When the synchronous speed, which corresponds to the high pole numbered winding, has been reached, and shortly after passing the synchronous speed, the low pole numbered winding is switched off and the high pole numbered winding is switched on. This causes the speed of the rotor to be reduced from the higher speed to the synchronous speed of the high pole numbered winding, the rotor remaining at this synchronous speed. This patent mainly concerns the possibility of letting the motor run at two definite speeds, which is obtained by a pole change from a first winding to a second winding.

The invention is based on the task of providing a method and an electric motor of the mentioned kind, which enables the synchronisation of the rotor speed with the rotating field generated by the stator windings when starting the motor against a high torque.

The method according to the invention involves that, when starting, the first auxiliary winding and a second auxiliary winding of the stator are alternatingly supplied with the alternating current in dependence of the alternating current polarity, until the rotor has reached an oversynchronous speed, after which the alternating current supply to the auxiliary windings is interrupted or reduced, the current of the auxiliary windings being supplied phase-shifted in relation to the alternating current being supplied to the main winding.

According to the invention, an electric motor as mentioned in the introduction is characterised in that the stator comprises a second auxiliary winding and the magnetic axes of the auxiliary windings define an angle. In this motor, it is preferably ensured that a device for controlling the current direction is arranged in series with each auxiliary winding and that a switching element is provided, which interrupts or reduces the alternating current supplied to the auxiliary windings, when the rotor has reached an oversynchronous speed.

A particularly simple embodiment of the motor according to the invention provides that the auxiliary windings respectively have a series-connected diode and form a parallel circuit, in which the diodes are oppositely poled, and that this parallel circuit, together with a series connection of a capacitor and the switching element, forms an additional series connection, which is parallel to the main winding.

Another embodiment of the motor according to the invention provides that the auxiliary windings, each connected in series with a diode, form a parallel circuit in which the diodes are oppositely poled, that the parallel circuit is connected in series with the switching element, that a capacitor is arranged between the connection of one diode with one auxiliary winding and the connection of the switching element not being connected with the parallel circuit, and that the series connection of the parallel circuit and the switching element is parallel to the main winding.

In the following, the invention and its embodiments are described on the basis of the enclosed drawings of preferred embodiments, showing:

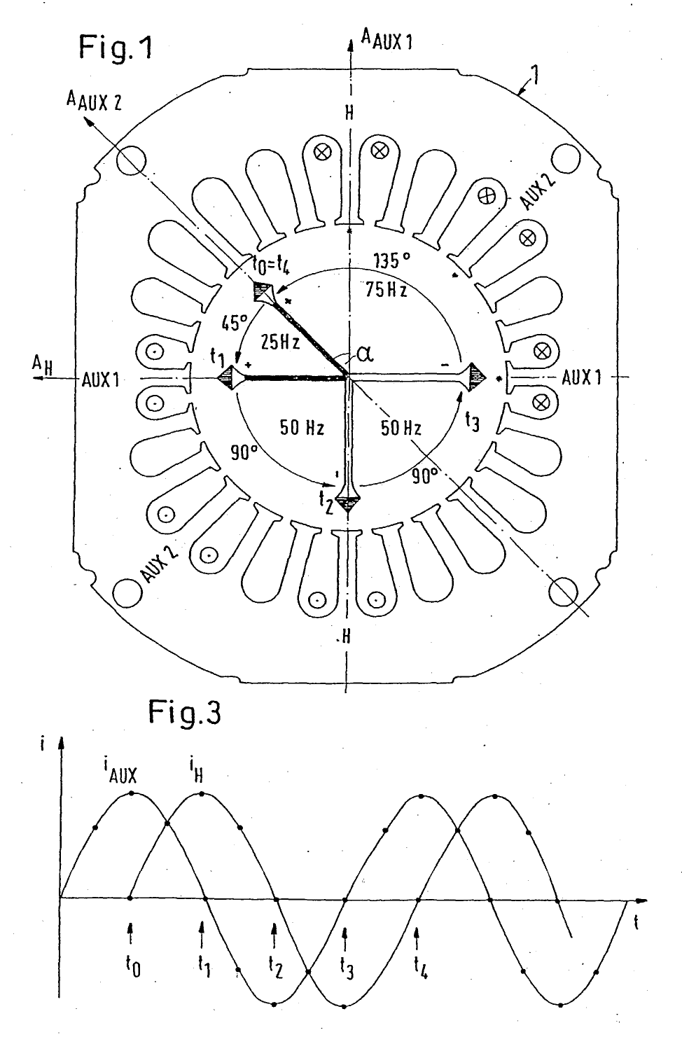

FIG. 1 an axial view of the stator of the motor according to the invention.

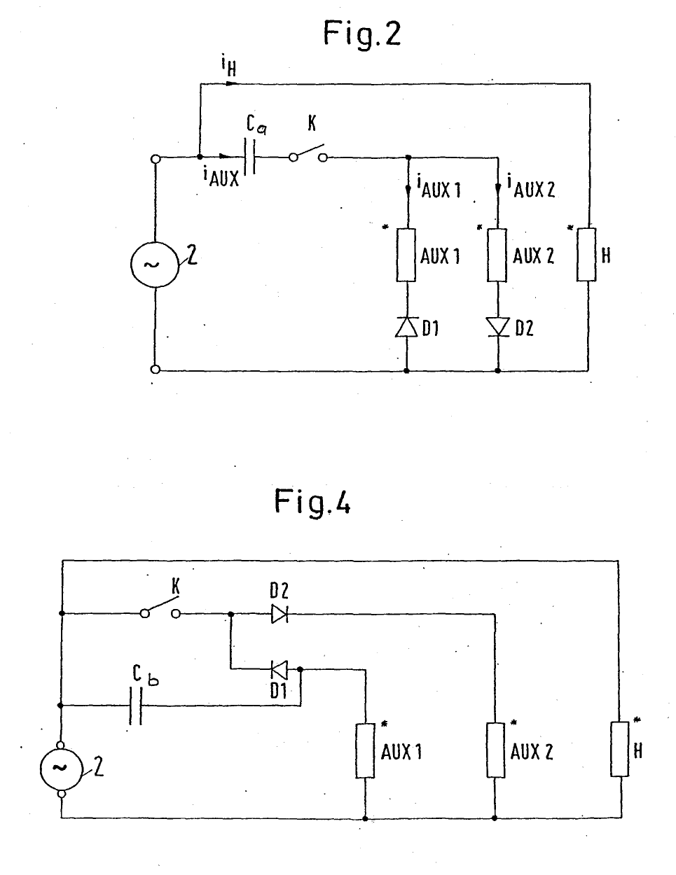

FIG. 2 a schematic circuit diagram of the motor, including a starting device.

FIG. 3 the time course of the currents in the main and auxiliary windings according to the circuit diagram in FIG. 2.

FIG. 4 a circuit diagram of a further embodiment of a motor according to the invention with a starting device according to the invention.

According to FIG. 1, the stator of a motor according to the invention comprises a two-pole main winding H and two two-pole auxiliary windings AUX1 and AUX2. Spatially, the first auxiliary winding AUX1 is displaced by 90° in relation to the main winding H, whereas the second auxiliary winding AUX2 is spatially displaced by 45° in relation to the main winding. The main winding H and the auxiliary windings AUX1 and AUX2 have the same number of poles.

In the bore of the stator 1 according to FIG. 1, there is a rotor, not shown, having permanent magnets and a pole number, which corresponds to the desired speed. Also here the pole number is two, that is, the rotor has one pole pair. Embodiments with higher pole numbers are also possible. Further, the rotor has several short-circuit windings, which are made as axially penetrating rods, as is the case in the rotor of a traditional asynchronous motor.

The circuit diagram according to FIG. 2 schematically shows the design of the motor with its starting device. The auxiliary windings AUX1 and AUX2, connected in series with a diode D1 and D2, form a parallel circuit, in which the diodes are oppositely poled. Together with a series connection of a capacitor C, which has a capacity of approximately 80 μF and functions as a starting capacitor, and a switching element K, this parallel circuit forms an additional series connection, which lies in parallel with the main winding H connected to a one-phase alternating voltage source 2 having the usual mains frequency of 50 Hz and a mains voltage of 220 V.

The switching element K can be an electronic switch, a centrifugal switch, a current relay or a PTC-resistor.

FIG. 3 shows the course of the current i_{H} through the main winding H and the current i_{AUX}, which, when starting with closed switching element K, flows alternatingly—because of the diodes D1 and D2—via the capacitor C and the switching element during one half-wave as a current i_{AUX1} through the first auxiliary winding AUX1 and during the second half-wave as a current i_{AUX2} through the second auxiliary winding AUX2, the current i_{AUX} being phase-displaced and leading by about 90° in relation to the current i_{H} because of the capacitor C. In principle, the capacitor C could be replaced by an inductive phase displacement arrangement, which is, for example, made in that the auxiliary windings AUX1 and AUX2 have a winding number and an ohmic resistance, which are different from those of the main winding H. This kind of phase displacement arrangements, however, only provide a small phase displacement. Thus, a capacitor is preferred. Alternatively, the phase displacement could also be effected by means of a two-phase alternating voltage source.

According to the invention, it is possible to synchronise the rotor with the rotating field, that is, to start the motor, within about five rotations of the rotating field. The first rotations are asynchronous, that is, the rotating field rotates faster than the rotor, but drags the rotor, so that its speed increases. Already during the fifth rotation, that is, about 100 ms after the closing of the switching element K, the rotor is synchronised with the rotating field. The times t₀ to t₄ in the FIGS. 1 and 3 concern the starting period of the rotating field, during which the rotor is synchronised with the rotating field. When, at the time t₀ the switching element K is closed, that is, during the zero crossing of the current i_{H} flowing through the main winding H, the auxiliary current i_{AUX} has its maximum positive amplitude. Due to the polarity of the diodes, the auxiliary current i_{AUX} flows through the second auxiliary winding AUX2. In FIG. 1, the positive current direction (vertically downwards in relation to the paper level) is indicated by means of a star at the second auxiliary winding AUX2. The rotating field generated between the stator 1 and the rotor is shown as a vector. The length of the vector is constantly equal to the vectorial sum of the vectors of the main winding H and the auxiliary winding concerned. At the time t₀, the current i_{H} through the main winding, as well as its magnetic field, is zero, whereas a current only flows through the second auxiliary winding AUX2, so that the vector of the resulting rotating field is equal to magnetic axis A_{AUX2} of the second auxiliary winding AUX2, shown in FIG. 1. If the vector in FIG. 1 is filled with black colour, this means that it is positive.

At the time t₁, the auxiliary current i_{AUX} is zero and the main current i_{H} is maximum. Thus, the resulting magnetic field is determined solely by the main current i_{H}, so that the vector coincides with the magnetic axis A_{H} of the main winding. In the period from t₀ to t₁, the vector passes a spatial angle of 45°. As the frequency of the alternating current is 50 Hz, the period from t₀ to t₁ or tₙ to tₙ₊₁, respectively, amounts to 5 ms. The vector usually rotates synchronously with the frequency of the alternating current. As, however, it only passes half of the spatial angle, namely 45° instead of 90°, in the same period of 5 ms, its frequency or angular speed is reduced to half of that of the alternating current frequency, that is, to 25 Hz.

In the period from t₁ to t₂, the spatial angle is equal to the electrical angle, and the vector again reaches a frequency of 50 Hz. At the time t₂ the auxiliary current i_{AUX}, being negative, flows through the auxiliary winding AUX1 in the opening direction of the diode D1. In FIG. 1, the vector at the time t₂ is not filled with black colour, to show that its polarity is negative.

As at the same time t₂ the main current i_{H} is zero, the vector coincides with the main axis A_{AUX1} of the auxiliary winding AUX1.

At the time t₃, the auxiliary current i_{AUX} is zero, whereas the main current i_{H} has its negative maximum. The rotating field vector therefore coincides with the axis A_{H} of the main field, and is turned 180° in relation to the position at the time t₁. The rotor now has a speed of approximately 47 Hz, that is, a small slip in relation to the vector frequency of 50 Hz. To synchronise the rotor with the rotating field vector, it is accelerated beyond the synchronous frequency of 50 Hz in the period from t₃ to t₄. The period from t₃ to t₄ corresponds to a spatial angle in the stator of 135°, which the vector must pass within the mentioned period of 5 ms. The frequency of the vector therefore increases to 75 Hz. This accelerates the rotor, so that at the time t₄ it has reached a higher frequency than 50 Hz, for example, 52 Hz. Both the rotating field (the vector) and the rotor are therefore accelerated for a short period. Shortly after reaching the synchronous speed, the switching element is automatically opened, that is, in case of a centrifugal switch by means of the centrifugal force, or by means of a timer, and the current supply to one or both auxiliary windings is interrupted. The speed of the rotor is now reduced from the higher value to the synchronous speed of 50 Hz, the two-pole embodiment of the motor according to FIG. 2 causing it to continue at this speed.

The path of acceleration of the rotor depends on the angle α between the magnetic axes A_{AUX1} and A_{AUX2} of the two auxiliary windings AUX1 and AUX2. In a two-pole motor the angle α preferably amounts to 45°. It could, for example, also be 60°, which would cause a longer path of acceleration of 150°. At the time t₄, not shown, the vector would then have a frequency of about 83 Hz, and the rotor would rotate at about 55 Hz. However, the braking in the area from t₀ t₁ would then be larger, and the rotating field, generated by the main winding H and the auxiliary winding AUX2 in this area, would be distorted.

The angle α depends on the pole number of the motor. In a four-pole motor (2 pole pairs), the vector rotates at half the frequency of the two-pole motor, that is, at 25 Hz. The angle α must be larger than zero and equal to or smaller than 45° (0<α≦45°). Preferably, the angle α is 22.5°. The corresponding path of acceleration angle then amounts to 67.5 °. For a short period, the vector reaches a maximum frequency of 37.5 Hz in the area of the acceleration angle. Generally speaking, the following applies for the angle α:

0<α≦180/p,

p being the number of poles.

The switching arrangement of the starting device with each of the diodes D1, D2 arranged in series with one of the auxiliary windings AUX1 and AUX2 according to FIG. 2 causes a continuous reversal of the current directions in the auxiliary windings AUX1 and AUX2 through the diodes D1 and D2. The auxiliary windings AUX1 and AUX2 cooperate in such a way that the interruption of the current through the diodes D1 and D2 will cause the other auxiliary winding to take over the inductive energy of the auxiliary winding just blocked. Further, the diodes ensure that each auxiliary winding only receives current during one of the two half-waves of the current i_{AUX}. This means that for the manufacturing and dimensioning of each of the two auxiliary windings, half the amount of copper will be sufficient, compared with a winding loaded with both half-waves.

Instead of the diodes, transistors or other controllable semi-conductor components can be used. However, these solutions are more expensive.

In the second embodiment according to FIG. 4, the diodes D1 and D2 are arranged outside the motor, not inside, like the embodiment according to FIG. 2. Again, the auxiliary windings AUX1 and AUX2, each connected in series with one of the diodes D1, D2, form a parallel circuit, in which the diodes are oppositely poled. This parallel circuit is also connected in series with the switching element K. The capacitor C is arranged between the connection of the one diode D1 with the one auxiliary winding AUX1 and the connection of the switching element K, which is not connected with the parallel circuit. Further, the series connection of the parallel circuit and the switching element K is parallel to the main winding H. The capacitor C has a capacity of about 4 μF and therefore practically only functions as a run capacitor.

In order to start, the switching element K is closed. During the positive half-waves of the alternating voltage produced by the alternating voltage source 2, current then flows through both auxiliary windings AUX1 and AUX2, and also through the main winding H. The phase shifting required for the generation of a rotating field is obtained by means of different impedances in the main winding and in the auxiliary windings. During the negative half-wave, the capacitor C can be regarded as short-circuited. The current then only flows through the auxiliary winding AUX1 and the main winding H. During operation, when the synchronous speed has been reached, the switching element K is opened. The current then flows via the capacitor C, on the one hand direct through the auxiliary winding AUX1 and on the other hand via the diodes D1 and D2 through the auxiliary winding AUX2. At the same time, the current flows through the main winding H. When the switching element K is opened, the current supply to the auxiliary winding AUX2 is reduced, as only positive half-waves reach AUX2. However, during operation the load on AUX2 interferes negatively on the rotating field, and to solve this problem, an additional switching element can be arranged between the diode D2 and the connecting point of the diode D1 with the switching element, the switching elements being opened simultaneously and the current supply to the auxiliary winding AUX2 being interrupted.

However, it is also possible, in the switching arrangement according to FIG. 4, to insert an additional capacitor in series with the switching element K and in front of the diodes D1, D2.

In the embodiment according to FIG. 4, the auxiliary winding AUX1 is preferably dimensioned so that the losses during run operation are at a minimum.

In the first embodiment according to FIG. 2, however, the auxiliary windings AUX1 and AUX2 are dimensioned for the largest starting torque.

Alternatively, it is possible to facilitate the starting of a three-phase Line-Start-Motor. This would require the arrangement of an auxiliary winding, that is, a fourth winding, in the stator, in such a way that the spatial angle between a main winding and the fourth winding amounts to more than 120°. This causes a path of acceleration angle, in which, for a short period, the vector is accelerated beyond the synchronous speed.

Patent claims:

1. Method for starting an electric motor, which comprises a stator (1) with a main winding (H) and a first auxiliary winding (AUX1), as well as a rotor with permanent magnets and at least one short-circuit winding, the motor being supplied with alternating current, characterised in that the first auxiliary winding (AUX1) and a second auxiliary winding (AUX2) of the stator (1) are alternatingly supplied with the alternating current in dependence of the alternating current polarity, until the rotor has reached an oversynchronous speed, after which the alternating current supply to the auxiliary windings (AUX1, AUX2) is interrupted or reduced, the current of the auxiliary windings (AUX1, AUX2) being supplied phase-shifted in relation the alternating current (i_{H}) being supplied to the main winding (H).

2. Electric motor with a device for starting the motor and the device to be connected with an alternating voltage source (2), with a stator (1) having a main winding (H) and a first auxiliary winding (AUX1), with a rotor having permanent magnets and at least one short-circuit winding, and with a phase shifting device (C, AUX1, H), which causes a phase shifting between the current flowing through the main winding (H) and that flowing through the auxiliary winding (AUX1), characterised in that the stator (1) has a second auxiliary winding (AUX2) with the same number of poles as the first auxiliary winding (AUX1), that the magnetic axes (A_{AUX1}, A_{AUX2}) of the auxiliary windings (AUX1, AUX2) define an angle (α), and that circuitry (K) is provided which interrupts or reduces the alternating current supplied to the auxiliary windings, when the rotor has reached an oversynchronous speed.

3. Motor according to claim 2, characterised in that a device (D1, D2) for controlling the current direction is arranged in series with each auxiliary winding and that a switching element (K) is provided, which interrupts or reduces the alternating current supplied to the auxiliary windings (AUX1, AUX2), when the rotor has reached an oversynchronous speed.

4. Motor according to claim 2 or 3, characterised in that the auxiliary windings (AUX1, AUX2) have a series-connected diode (D1, D2) and form a parallel circuit, in which the diodes are oppositely poled, and that this parallel circuit, together with a series connection of a capacitor (C) and the switching element (K), forms an additional series connection, which is parallel to the main winding (H).

5. Motor according to claim 2 or 3, characterised in that the auxiliary windings (AUX1, AUX2), each connected in series with a diode (D1, D2, form a parallel circuit (AUX1, AUX2, D1, D2). In which the diodes are oppositely poled, that the parallel circuit is connected in series with the switching element (K), that a capacitor (C) is arranged between the connection of one diode (D1) with one auxiliary winding (AUX1) and the connection of the switching element (K) not being connected with the parallel circuit, and that the series connection of the parallel circuit and the switching element (K) is parallel to the main winding (H).
